(19) United States
(12) Patent Application Publication
(10) Pub. No.: US 2009/0157940 A1
(43) Pub. Date: Jun. 18, 2009

(54) Techniques For Storing Data In Multiple Different Data Storage Media

(75) Inventor: Marco Sanvido, Belmont, CA (US)

Correspondence Address: STEVEN J. CAHILL/ HITACHI GST, P.O. Box 779, MENLO PARK, CA, 94026-0779, US

(73) Assignee: Hitachi Global Storage Technologies Netherlands, B.V., Amsterdam (NL)

(21) Appl. No.: 11/957,435

(22) Filed: Dec. 15, 2007

(51) Int. Cl. G06F 12/06

(52) U.S. Cl. 711/5; 711/4

(57) ABSTRACT

A data storage system comprises a first data storage medium and a second data storage medium. The first and the second data storage media are different types of data storage media. The data storage system assigns a first range of logical block addresses to physical addresses in the first data storage medium. The data storage system is configured to dynamically reassign the first range of logical block addresses to physical addresses in the second data storage medium. Alternatively, the data storage system can assign a first range of logical block addresses to physical addresses in the first data storage medium and to physical addresses in the second data storage medium. The data storage system stores data associated with the first range of logical block addresses in both of the first and the second data storage media. One of the data storage media can be NAND Flash memory.

### CROSS-REFERENCES TO RELATED APPLICATIONS

This application is related to commonly assigned U.S. patent application Ser. No. ______, (Attorney Docket Number HSJ9-2007-0209-US1), filed concurrently herewith, to Marco Sanvido, which is incorporated by reference herein.

### BACKGROUND OF THE INVENTION

The present invention relates to data storage systems, and more particularly, to techniques for storing data in multiple different types of data storage media.

A hard disk drive is a type of data storage device. A hard disk drive stores data onto the surface of one or more hard disk platters as a magnetic image. Other types of data storage devices include flash memory devices and optical disk drives such as CD and DVD drives.

### BRIEF SUMMARY OF THE INVENTION

According to some embodiments of the present invention, a data storage system comprises a first data storage medium, a second data storage medium, and a controller. The first and the second data storage media are different types of data storage media. The controller processes read and write commands to the first data storage medium and to the second data storage medium during a data access mode of operation. The data storage system assigns a first range of logical block addresses (LBAs) to physical addresses in the first data storage medium. The data storage system is configured to dynamically reassign the first range of logical block addresses to physical addresses in the second data storage medium during the data access mode of operation.

According to other embodiments, the data storage system assigns a range of logical block addresses to physical addresses in the first data storage medium and to physical addresses in the second data storage medium. The data storage system stores data associated with the range of logical block addresses in both of the first and the second data storage media. According to yet another embodiment, one of the data storage media includes NAND Flash memory.

Various objects, features, and advantages of the present invention will become apparent upon consideration of the following detailed description and the accompanying drawings.

### BRIEF DESCRIPTION OF THE DRAWINGS

FIG. 1 illustrates a diagram of a computer system, according to an embodiment of the present invention.

FIG. 2 illustrates an example of how a set of logical block addresses can be mapped to different types of data storage media, according to an embodiment of the present invention.

FIG. 3 illustrates an example of a data storage system mapping one range of logical block addresses (LBAs) to two different types of data storage media, according to an embodiment of the present invention.

### DETAILED DESCRIPTION OF THE INVENTION

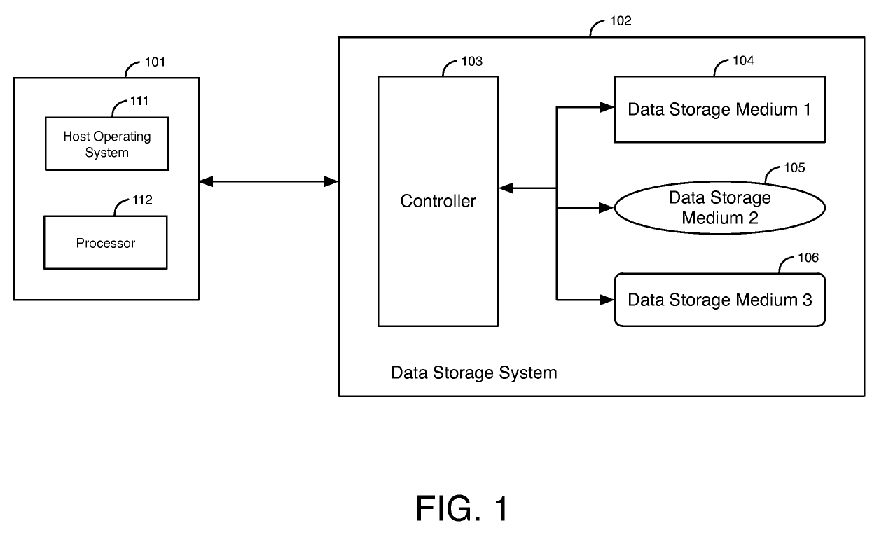

FIG. 1 illustrates a diagram of a computer system, according to an embodiment of the present invention. The computer system of FIG. 1 includes a host system 101 and a data storage system 102. Host system 101 includes a host operating system 111 and a processor 112. Host operating system 111 is executed on processor 112. Host system 101 can be part of the same computer machine as data storage system 102 or part of a different computer machine.

Data storage system 102 includes a controller 103, a first data storage medium 104, a second data storage medium 105, and a third data storage medium 106. Controller 103 is typically fabricated on an integrated circuit. Controller 103 processes read and write commands from host system 101. Controller 103 also communicates with each of the data storage media 104-106 through one or more communications channels. Controller 103 causes data to be read from and written to data storage media 104-106 in response to read and write commands from host system 101.

Each of the data storage media 104-106 is a non-volatile data storage medium. In one embodiment, data storage system 102 is a single data storage device that has 3 different types of data storage media. The data storage media can include, for example, an optical disk, a magnetic hard disk, magnetic tape, and non-volatile semiconductor memory.

Data storage media 104-106 can be different types of data storage media. The different types of data storage media 104-106 can, for example, use different techniques for storing data. For example, data storage media 104-106 can include a magnetic hard disk that stores data as magnetic patterns. As another example, data storage media 104-106 can include an optical disk such as a compact disc (CD) or a digital video disc (DVD) that stores data as a set of optical images. As yet another example, data storage media 104-106 can include non-volatile semiconductor memory such as a NAND Flash memory or another type of Flash memory that stores data as charge in circuits. According to other examples, data storage media 104-106 can include a magnetic tape or a magnetic floppy disk that stores data as magnetic patterns.

Data storage system 102 is configured to map logical block addresses (LBAs) to physical addresses in different types of non-volatile data storage media 104-106. The physical addresses typically have different numerical values than the LBAs, but the physical addresses and the LBAs can have the same numerical values. In a hard disk drive, the physical addresses can be cylinder head sector numbers.

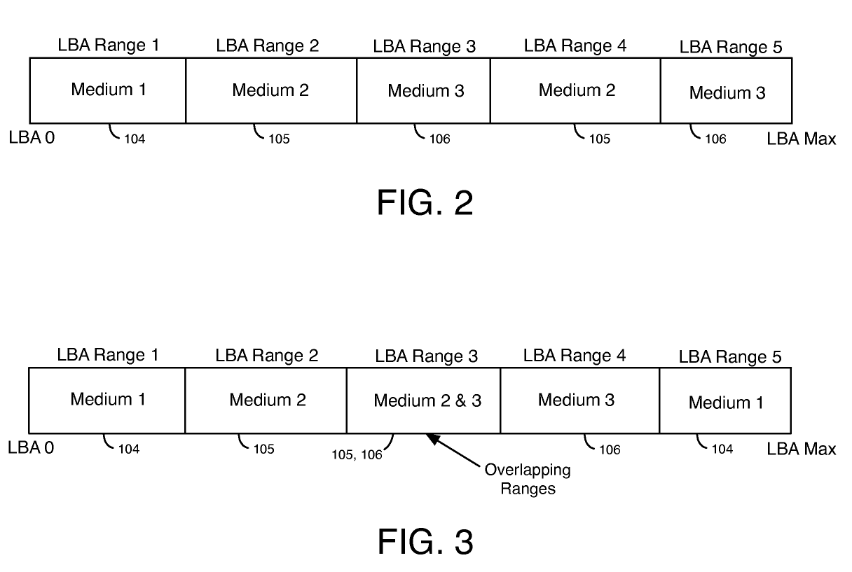

FIG. 2 illustrates an example of how a set of logical block addresses can be mapped to different types of data storage media, according to an embodiment of the present invention. Initially, data storage system 102 receives a command from host system 101 (or from another source) to partition a set of logical block addresses among 2 or more different types of data storage media. In response to this command, data storage system 102 assigns the set of logical block addresses to physical addresses in the requested data storage media during a configuration setup procedure.

The physical addresses correspond to units of storage space (e.g., sectors) in a particular data storage medium. Each data storage medium 104-106 has a physical address assigned to each of its units of storage space. Each physical address assigned to a unit of storage space in a data storage medium is unique with respect to the other physical addresses assigned to other units of storage space in that data storage medium.

In the example shown in FIG. 2, the set of LBAs assigned to data storage media 104-106 ranges from 0 to a maximum LBA. The set of LBAs can contain sequential logical block addresses. For example, data storage medium 104 can be assigned to LBAs 0-500, data storage medium 105 can be assigned to LBAs 501-1000, and data storage medium 106 can be assigned to LBAs 1001-2000. Alternatively, the set of LBAs assigned to data storage media 104-106 can be non-sequential logical block addresses. For example, data storage medium 104 can be assigned to LBAs 0-300, data storage medium 105 can be assigned to LBAs 600-1000, and data storage medium 106 can be assigned to LBAs 1500-2000.

In the example of FIG. 2, data storage system 102 assigns a first range of the LBAs to physical addresses in the first data storage medium 104. Therefore, data associated with the first range of LBAs is stored in data storage medium 104. Data storage system 102 assigns a second range of the LBAs to physical addresses in the second data storage medium 105. Therefore, data associated with the second range of LBAs is stored in data storage medium 105. Data storage system 102 assigns a third range of the LBAs to physical addresses in the third data storage medium 106. Therefore, data associated with the third range of LBAs is stored in data storage medium 106. Data storage system 102 assigns a fourth range of the LBAs to physical addresses in the second data storage medium 105. Therefore, data associated with the fourth range of LBAs is stored in data storage medium 105. Data storage system 102 assigns a fifth range of LBAs to physical addresses in the third data storage medium 106. Therefore, data associated with the fifth range of LBAs is stored in data storage medium 106.

Data storage system 102 can assign LBAs that are not numerically continuous to physical addresses in a data storage medium that are numerically continuous. For example, data storage system 102 can assign LBAs 501-600 to physical addresses 0-99 in data storage medium 106 and LBAs 801-900 to physical addresses 100-199 in data storage medium 106, while assigning LBAs 601-800 to physical addresses 0-199 in data storage medium 105.

According to one embodiment, data storage system 102 statically maps one or more ranges of LBAs to two or more different types of data storage media, such as media 104-106, where one of the data storage media is a NAND Flash memory circuit. In this embodiment, the mapping of the LBA ranges to physical addresses in particular types of media does not change during the data access mode of operation of data storage system 102. The data access mode of operation occurs when data storage system 102 is in a mode that allows it to perform data accesses to and from at least one of media 104-106 in response to requests from host system 101. In this embodiment, controller 103 can only reassign an LBA range to a different set of physical addresses in the same media or in a different media type during a configuration setup mode, during which data accesses are not performed.

According to another embodiment, data storage system 102 is configured to map and to dynamically re-map LBA ranges between two or more different types of data storage media, such as media 104-106, during the data access mode of operation of data storage system 102, without having to return to a configuration setup mode. For example, data storage system 102 can initially assign an LBA range of 0-100 and 400-800 to physical addresses in data storage medium 104, an LBA range of 1000-1500 to physical addresses in data storage medium 105, and an LBA range of 1501-1900 to physical addresses in data storage medium 106. Subsequently, data storage system 102 can dynamically reassign LBA range 400-800 to physical addresses in data storage medium 105 and reassign LBA range 1000-1500 to physical addresses in data storage medium 106 during the data access mode of operation of data storage system 102, without changing the mapping of the other LBA ranges 0-100 and 1501-1900.

Data storage system 102 can dynamically re-map LBA ranges to different types of data storage media in response to commands from host system 101 or from another source. For example, controller 103 can dynamically re-map an LBA range from a magnetic hard disk to an optical disk or to NAND Flash memory during the data access mode of operation. Controller 103 can, for example, re-map an LBA range to a different type of data storage medium if the original data storage medium assigned to that LBA range fails or has a slow data access response delay for a particular application.

After the logical block addresses have been mapped to physical addresses in media 104-106, host system 101 sends a subset of those LBAs to data storage system 102 along with each read command and each write command to access data from data storage media 104, 105, and 106. After data storage system 102 receives a command and LBAs from host system 101, controller 103 maps the LBAs received from host 101 to physical addresses in one or more of data storage media 104-106 using the previous mapping of LBAs to physical addresses in each data storage medium. Controller 103 then reads data from or writes data to the one or more mapped data storage media 104-106.

The properties of the logical block addresses may need to be changed based on the changing requirements for the file system or for a software application using the data storage system. According to some embodiments, logical block addresses (LBAs) associated with data are dynamically re-mapped to a different type of data storage medium that suits the new properties of the data associated with the LBAs during the data access mode of operation. For example, a file system or software application (e.g., a database application) in host 101 may initially need very fast response times for read and write random accesses to a particular set of data. Data storage system 102 can map the LBAs associated with that data to Flash memory to provide fast read and write random access response times. Subsequently, the file system or software application may no longer need fast random access times for the data, and may require the data to be stored in a reliable backup data storage medium that has a large amount of storage capacity. Data storage system 102 can then dynamically re-map the LBAs associated with that data to magnetic tape or to a magnetic hard disk platter during the data access mode of operation.

According to another embodiment, logical block addresses are interleaved between two or more different types of data storage media. FIG. 2 illustrates an example of interleaving, because a second range of LBAs are assigned to medium 105, a third range of LBAs are assigned to medium 106, a fourth range of LBAs are assigned to medium 105, and a fifth range of LBAs are assigned to medium 106, as described above. As another example of interleaving, controller 103 can assign a first range of LBAs to physical addresses in data storage medium 104, a second range of LBAs to physical addresses in data storage medium 105, a third range of LBAs to physical addresses in data storage medium 104, a fourth range of LBAs to physical addresses in data storage medium 105, a fifth range of LBAs to physical addresses in data storage medium 104, and a sixth range of LBAs to physical addresses in data storage medium 105. FIG. 3 illustrates another example of interleaving between three data storage media 104-106.

FIG. 3 illustrates an example of a data storage system mapping one range of logical block addresses (LBAs) to two different types of data storage media, according to an embodiment of the present invention. Data storage system 102 can selectively mirror a range of LBAs among data storage media by mapping that range of LBAs to two or more different types of data storage media.

In the embodiment of FIG. 3, the third range of LBAs is mapped to physical addresses that are assigned to units of storage space in two different types of data storage media 105 and 106. Thus, the third range of LBAs overlaps both data storage media 105 and 106. As a result, when host system 101 indicates to data storage system 102 to store data in the third range of LBA, data storage system 102 stores that data in data storage medium 105 and in data storage medium 106.

By mapping a subset of LBAs to two or more different types of data storage media, data storage system 102 significantly increases the reliability of the data associated with that range of LBAs. Two different types of data storage media are less likely to fail at the same time.

In addition, mapping LBAs to two different types of data storage media can also significantly decrease the read access time for data associated with those LBAs. For example, Flash memory devices typically have fast random access times and slower continuous data transfer times. Hard disk drives typically have fast continuous data transfer times for accessing a continuous range of physical addresses and slower random access times. Thus, data storage system 102 can significantly decrease the read access time of data that is stored in both Flash memory and in a magnetic hard disk. Each time data storage system 102 requests data, the data are accessed from both the Flash memory and the magnetic hard disk. Whichever data storage medium is faster at accessing that data returns the data to controller 103 first. Then, the data received at controller 103 first are transferred to host 101.

Mapping LBAs to two different types of data storage media can also significantly decrease the write time to store data associated with those LBAs. For example, data storage system 102 can immediately write data associated with a range of LBAs to the data storage medium that performs faster write operations. Then, data storage system 102 can copy the data associated with that range of LBAs from the faster data storage medium to the other, slower data storage medium in the background, after the data has been written to the faster data storage medium. This technique ensures that the data is written to at least one data storage medium soon after the write command is issued, while the data is copied to a second data storage medium later when system 102 is less busy.

In the example of FIG. 3, data storage system 102 assigns a first range of the LBAs to physical addresses in the first data storage medium 104. Therefore, data associated with the first range of LBAs is stored in data storage medium 104. Controller 103 assigns a second range of the LBAs to physical addresses in the second data storage medium 105. Therefore, data associated with the second range of LBAs is stored in data storage medium 105. Controller 103 assigns a third range of the LBAs to physical addresses in the second and the third data storage media 105 and 106. Therefore, data associated with the third range of LBAs is stored in both of the data storage media 105 and 106. Controller 103 assigns a fourth range of the LBAs to physical addresses in the third data storage medium 106. Therefore, data associated with the fourth range of LBAs is stored in data storage medium 106. Controller 103 assigns a fifth range of LBAs to physical addresses in the first data storage medium 104. Therefore, data associated with the fifth range of LBAs is stored in data storage medium 104.

According to one embodiment, data storage system 102 can map and dynamically re-map a range of LBAs to two or more different types of data storage media so that data associated with these LBAs is stored in the two or more different types of data storage media. For example, data storage system 102 can initially map the third range of LBAs to physical addresses in data storage media 105 and 106 as shown in FIG. 3 so that data associated with the third range of LBAs is stored in both of media 105 and 106. Subsequently, data storage system 102 can dynamically re-map the third range of LBAs to physical addresses in data storage medium 104 and to a different set of physical addresses in data storage medium 106 during the data access mode of operation. Thus, the data associated with the third range of LBAs continues to be stored in two data storage media 104 and 106 after the dynamic re-mapping.

According to yet another embodiment, data storage system 102 can map and dynamically re-map a range of LBAs to physical addresses in three or more different types of data storage media 104-106.

The foregoing description of the exemplary embodiments of the present invention has been presented for the purposes of illustration and description. It is not intended to be exhaustive or to limit the present invention to the examples disclosed herein. A latitude of modification, various changes, and substitutions are intended in the present invention. In some instances, features of the present invention can be employed without a corresponding use of other features as set forth. Many modifications and variations are possible in light of the above teachings, without departing from the scope of the present invention.

For example, embodiments of the present invention may be implemented using one or a combination of hardware, software, and a computer-readable medium containing program instructions. Software implemented by embodiments of the present invention and results of the present invention may be stored in a computer-readable medium such as memory, hard disk drive, CD, DVD, or other media. Results of the present invention may be used for various purposes such as being executed or processed by a processor, being displayed to a user, transmitted in a signal over a network, etc.

What is claimed is:

1. A data storage system comprising:
a first data storage medium;
a second data storage medium, wherein the first and the second data storage media are different types of data storage media; and
a controller for processing read and write commands to the first data storage medium and to the second data storage medium during a data access mode of operation,
wherein the data storage system assigns a first range of logical block addresses to physical addresses in the first data storage medium, and
wherein the data storage system is configured to dynamically reassign the first range of logical block addresses to physical addresses in the second data storage medium during the data access mode of operation.

2. The data storage system defined in claim 1 wherein the data storage system assigns a second range of logical block addresses to physical addresses in the second data storage medium, and the data storage system is configured to dynamically reassign the second range of logical block addresses to physical addresses in the first data storage medium during the data access mode of operation.

3. The data storage system defined in claim 2 wherein the data storage system causes data associated with the first range of logical block addresses to be stored in the first data storage medium, and the data storage system causes data associated with the second range of logical block addresses to be stored in the second data storage medium.

4. The data storage system defined in claim 2 wherein the data storage system assigns a third range of logical block addresses to physical addresses in a third data storage medium, wherein the first, the second, and the third data storage media are three different types of data storage media, and wherein the data storage system is configured to dynamically reassign the third range of logical block addresses to physical addresses in the second data storage medium during the data access mode of operation.

5. The data storage system defined in claim 1 wherein the data storage system interleaves logical block addresses between the first and the second data storage media.

6. The data storage system defined in claim 1 wherein the first data storage medium is NAND Flash memory, and the second data storage medium is a magnetic hard disk.

7. The data storage system defined in claim 1 wherein the first data storage medium is an optical disk, and the second data storage medium is NAND Flash memory.

8. The data storage system defined in claim 1 wherein the first data storage medium is a magnetic hard disk, and the second data storage medium is magnetic tape.

9. The data storage system defined in claim 1 wherein the first data storage medium is a magnetic hard disk, and the second data storage medium is an optical disk.

10. The data storage system defined in claim 1 wherein the first and the second data storage media are selected from the group consisting of magnetic hard disk, magnetic tape, optical disk, and Flash semiconductor memory.

11. The data storage system defined in claim 1 wherein the data storage system assigns a second range of logical block addresses to physical addresses in the first data storage medium and to physical addresses in the second data storage medium, wherein the data storage system stores data associated with the second range of logical block addresses in both of the first and the second data storage media, and wherein the data storage system is configured to dynamically reassign the second range of logical block addresses to a different set of physical addresses in at least one of the first and the second data storage media.

12. A data storage system comprising:
a first data storage medium;
a second data storage medium, wherein the first and the second data storage media are different types of data storage media; and
a controller for processing read and write commands to the first data storage medium and to the second data storage medium,
wherein the data storage system assigns a first range of logical block addresses to physical addresses in the first data storage medium, and the data storage system assigns the first range of logical block addresses to physical addresses in the second data storage medium, and
wherein the data storage system stores data associated with the first range of logical block addresses in both of the first and the second data storage media.

13. The data storage system defined in claim 12 wherein the data storage system assigns a second range of logical block addresses to physical addresses in the second data storage medium, and wherein the data storage system dynamically reassigns the second range of logical block addresses to physical addresses in the first data storage medium during a data access mode of operation.

14. The data storage system defined in claim 12 wherein the data storage system dynamically reassigns the first range of logical block addresses to a different set of physical addresses in at least one of the first and the second data storage media during a data access mode of operation.

15. The data storage system defined in claim 12 wherein the data storage system interleaves at least one range of logical block addresses between the first and the second data storage media.

16. The data storage system defined in claim 12 wherein at least one of the first and the second data storage media is NAND Flash memory.

17. The data storage system defined in claim 12 wherein the first and the second data storage media are selected from the group consisting of magnetic hard disk, magnetic tape, optical disk, and Flash semiconductor memory.

18. The data storage system defined in claim 12 wherein the data storage system assigns the first range of logical block addresses to physical addresses in a third data storage medium, wherein the first, the second, and the third data storage media are three different types of data storage media, and wherein the data storage system stores the data associated with the first range of logical block addresses in the first, the second, and the third data storage media.

19. A data storage system that comprises code for storing data in multiple different types of data storage media, wherein the code is stored in a computer readable medium in the data storage system, the data storage system comprising:
code for processing read and write commands to a first data storage medium and to a second data storage medium, wherein the first and the second data storage media are different types of data storage media;
code for assigning a first range of logical block addresses to physical addresses in the first data storage medium, and assigning a second range of logical block addresses to physical addresses in the second data storage medium, wherein the first data storage medium comprises NAND Flash memory; and
code for storing data associated with the first and the second ranges of logical block addresses in the first and the second data storage media at the physical addresses assigned to the respective logical block addresses.

20. The data storage system defined in claim 19 further comprising code for dynamically reassigning the second range of logical block addresses to physical addresses in the first data storage medium during a data access mode of operation of the data storage system.
